(19) United States
(12) Patent Application Publication
(10) Pub. No.: US 2006/0120258 A1
(43) Pub. Date: Jun. 8, 2006

(54) Optical disc, optical disc apparatus, optical disc reproducing method, and digital content publication

(75) Inventors: Toshihiro Sugaya, Moriya-shi (JP); Hisashi Yamada, Yokohama-shi (JP); Masato Otsuka, Tokyo (JP)

Correspondence Address: PILLSBURY WINTHROP SHAW PITTMAN, LLP, P.O. BOX 10500, MCLEAN, VA, 22102, US

(73) Assignees: KABUSHIKI KAISHA TOSHIBA, Tokyo (JP); MEMORY-TECH CORPORATION, Chikusei-city (JP)

(21) Appl. No.: 11/292,140

(22) Filed: Dec. 2, 2005

(30) Foreign Application Priority Data
Dec. 2, 2004 (JP) 2004-350104

(51) Int. Cl. G11B 7/24

(52) U.S. Cl. 369/275.1; 369/283

(57) ABSTRACT

This invention enables a single disc to deal with HD DVD information and DVD information. An optical disc according to the present invention is basically specified by the following items (1) the optical disc is a single-sided dual layer optical disc, (2) the distance in the light transmission layer from an incidence plane to a first recording layer is 578 to (578+2p) μm (2p is the maximum value of substrate thickness accuracy), (3) the distance in the space layer between the first recording layer and a second recording layer is (62−2p−2q) to (62−2p) μm (2q is the maximum value of space layer thickness accuracy), and (4) the areal recording density of the first recording layer is three times or more as high as that of the second recording layer.

### CROSS-REFERENCE TO RELATED APPLICATIONS

This application is based upon and claims the benefit of priority from prior Japanese Patent Application No. 2004-350104, filed Dec. 2, 2004, the entire contents of which are incorporated herein by reference.

### BACKGROUND OF THE INVENTION

1. Field of the Invention

This invention relates to an optical disc acting as a medium which stores digitized audio and visual content, including movies and music, such as a Digital Versatile Disc (DVD). This invention further relates to an optical disc apparatus which reads the recorded information on the optical disc, an optical disc reproducing method, and a digital content publication using an optical disc as a recording medium.

2. Description of the Related Art

<Outline of the DVD Standard>

One known type of optical disc for storing digital images is the Digital Versatile Disc (DVD), which has been widely used all over the world mainly in storing and delivering movie content (digital content publications). DVD is the standard determined by the DVD Forum, which is open to the public as the DVD standard (DVD Book) (refer to www.dvdforum.org). The DVD standard has also been determined in international standards and JIS. Here, ECMA-267 is a document related to the International standard on 120 mm DVD-ROM, one of the DVD physical standards. Hereinafter, a brief explanation will be given referring to ECMA-267.

There are four types of 120 mm DVD-ROM: single-sided single layer, single-sided dual layer, double sided single layer, and double sided dual layer. In delivery of an accumulation of content, such as movies, there are two types of single-sided discs: one is a single-sided single layer disc with a capacity of 4.7 GB and the other is a single-sided dual layer disc with a capacity of 4.27 GB per layer (a total capacity of 8.54 GB per disc).

The development of a disc whose capacity is larger than that of the aforementioned DVD (referred to as the existing DVD) has been desired. This comes from a desire to store HD (High Definition) images into a single disc (temporarily referred to as the next-generation DVD).

If the next generation DVD is developed, it will be possible to design a next-generation DVD unit (drive or player) for the next-generation DVD so as to read not only the next-generation DVD but also the existing DVD. Since the next-generation DVD differs greatly from the existing DVD in recording density, modulation system, signal processing, track format, and the like, a conventional DVD unit (drive or player) cannot read the data from the next-generation DVD. That is, the conventional DVD unit has the disadvantage of being unable to read not only HD movie content recorded on the next-generation DVD disc but also conventional DVD movie content recorded on the next-generation DVD, which may lead to a factor that hinders the spread of the next-generation DVD.

### BRIEF SUMMARY OF THE INVENTION

An object of the present invention is to provide an optical disc, an optical disc apparatus, and an optical disc reproducing method which enable a single disc to deal with not only information recorded on the next-generation DVD but also information recorded on the existing DVD, and further provide digital content publication using an optical disc as a recording medium.

According to an aspect of the present invention, there is provided an optical disc with a single-sided dual layer where a light transmission layer, a first recording layer accessed with a first laser beam, a space layer, and a second recording layer accessed with a second laser beam are arranged in that order in the direction in which a laser beam enters, the optical disc characterized in that: the distance in the light transmission layer from an incidence plane to the first recording layer is 578 μm to 598 μm; the distance in the space layer between the first recording layer and the second recording layer is 32 μm to 42 μm; and the areal recoding density of the first recording layer is three times or more as high as that of the second recording layer.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows the relationship between the basic structure of a single-sided single layer DVD disc and an optical head;

FIGS. 2A and 2B each show the position of the recording layer of a single-sided single layer DVD disc;

FIG. 3 shows the relationship between the basic structure of a single-sided dual layer DVD disc and an optical head;

FIG. 4 shows the position of the recording layer of a single-sided dual layer DVD disc;

FIG. 5 shows the relationship between the basic structure of a single-sided single layer HD DVD disc and an optical head;

FIG. 6 shows the relationship between the basic structure of a single-sided dual layer HD DVD disc and an optical head;

FIG. 7 shows the position of the recording layer of a single-sided dual layer HD DVD disc;

FIG. 8 shows the relationship between an optical disc and the reproducing optical system in the present invention;

FIG. 9 shows the relationship between an optical disc and a red laser beam in the present invention;

FIG. 10 shows the relationship between an optical disc and a blue-violet laser beam in the present invention;

FIG. 11 shows the configuration of an optical disc apparatus complying with the DVD standard;

FIG. 12A is a flowchart to help explain the operation of the optical disc apparatus complying with the DVD standard;

FIG. 12B shows an example of focus signals detected by the optical disc apparatus of FIG. 12A;

FIG. 13 shows the configuration of an optical disc apparatus complying with the HD DVD standard;

FIG. 14A is a flowchart to help explain the operation of the optical disc apparatus complying with the HD DVD standard;

FIG. 14B shows an example of focus signals detected by the optical disc apparatus of FIG. 14A;

FIG. 15 shows the configuration of an optical disc apparatus according to the present invention; and

FIG. 16 is a flowchart to help explain the operation of the optical disc apparatus according to the present invention.

### DETAILED DESCRIPTION OF THE INVENTION

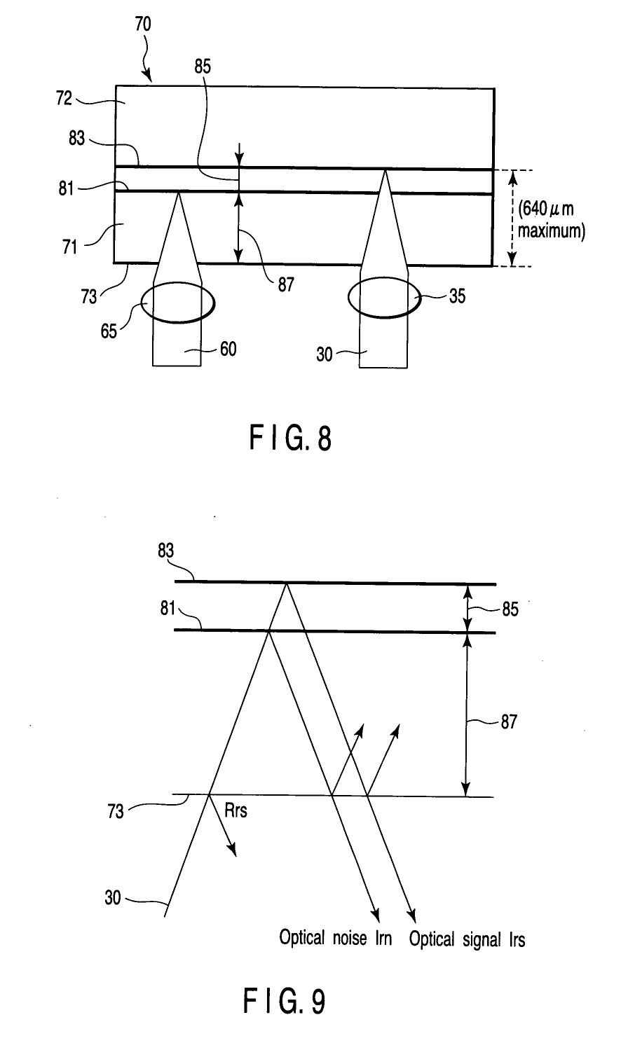

Hereinafter, referring to the accompanying drawings, embodiments of the present invention will be explained. To make it easier to understand the present invention, the technologies of the existing DVD and the next-generation DVD will be explained. Then, the basic configuration of the next-generation DVD according to the present invention will be explained using FIG. 8.

<Single-Sided Single Layer DVD>

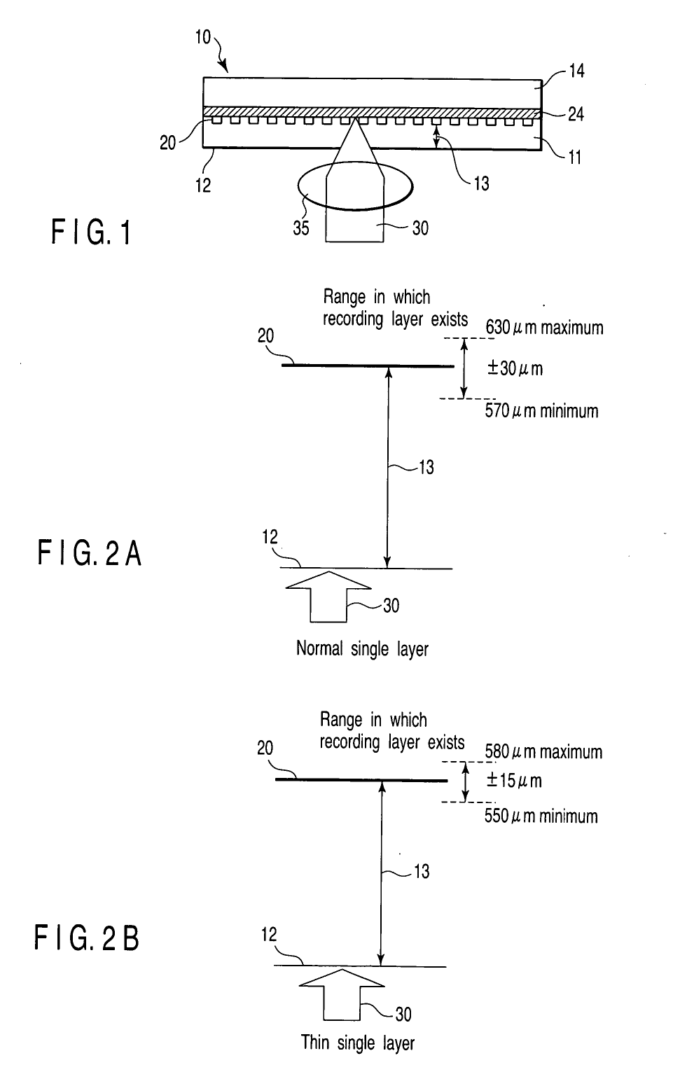

FIG. 1 shows the relationship between the basic structure of a single-sided single layer DVD disc 10 and an optical head. As is well known, the DVD disc 10 has such a structure that bonded two 0.6 mm thickness disc substrates together. One of the substrates is a signal substrate 11 and the other is a dummy substrate 14. The signal substrate and the dummy substrate are bonded together with an adhesive layer 24 in such a manner that a recording layer 20 lies between the two substrates. Generally, these substrates are made of such plastic material as polycarbonate with an injection molding machine.

In the signal substrate 11, video information, data information, and the like are recorded in a spiral track in the form of emboss pits. Red laser light 30 (with a wavelength of 650 nm) for reading the information in the recording layer is stopped down at an objective lens 35 (of NA 0.6), passes through a light transmission layer 13 of the signal substrate 11, and is focused on the recording layer 20.

Each of FIGS. 2A and 2B shows the position of the recording layer of a single-sided single layer disc when viewed from an incidence plane 12. FIG. 2A shows a normal single layer conventionally used. In the normal single layer, the center value of the thickness of the light transmission layer 13 is 600 μm and lies in a position a minimum distance of 570 μm and a maximum distance of 630 μm away from the incidence plane. The value is determined, taking the spherical aberration of the objective lens 35 into account. Recently, a thin single layer where the center value of the recording layer is 565 μm and lies in a position a minimum distance of 550 μm and a maximum distance of 580 μm away from the incidence plane even in a single-sided single layer disc has been added to the DVD standard (refer to www.dvdforum.org or DVD Book). In this disc, jitter is determined less than 7% to secure interchangeability in reading with a conventional apparatus, whereas in the normal signal layer, jitter is determined less than 8%.

<Single-Sided Dual Layer DVD>

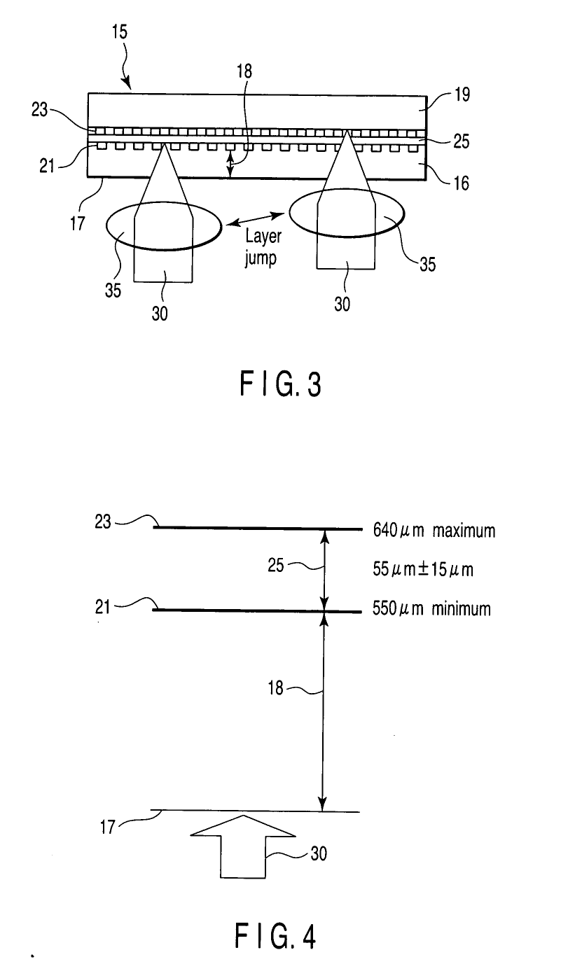

FIG. 3 shows the relationship between the basic structure of a single-sided dual layer disc 15 and an optical head. As is well known, this disc has a first recording layer 21 and a second recording layer 23. The two recording layers can be accessed from one side of the disc, thereby reproducing the signal. In FIG. 3, when viewed from the incidence plane 17, there are a light transmission layer 18, the first recording layer 21, and the second recording layer 23 in that order. The individual recording layers are accessed by moving the objective lens 35 with a lens actuator and causing the objective lens 35 to make a layer jump.

The dual layer disc is characterized in that it can be produced almost in the same manner as a single-sided single layer disc. A signal substrate 16 where the first recording layer 21 is to be formed and a signal substrate 19 where the second recording layer 23 is to be formed are produced separately with an injection molding machine. Next, a semi-transparent film is provided on the first recording layer 21 and a high-reflectivity film is provided on the second recording film 23. Then, the two substrates are bonded together with a space layer 25 in such a manner that the recording layers lie between the two substrates, which completes the disc.

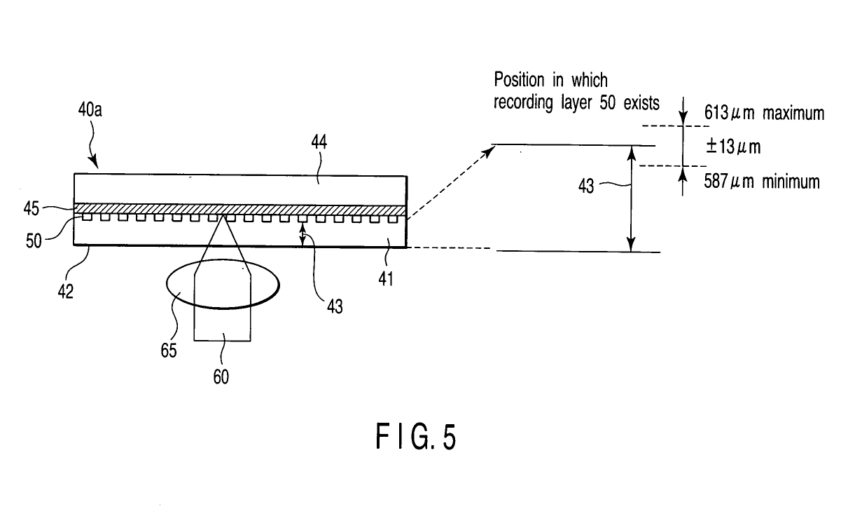

FIG. 4 shows the position of the recording layers when viewed from the incidence plane 17 of the single-side dual layer disc. The first recording layer 21 is limited to a position a minimum distance of 550 μm away from the incidence plane and the second recording layer 23 is limited to a position a maximum distance of 640 μm away from the incidence plane and the distance between the two layers (or space layer 25) is set as 55±15 μm (40 to 70 μm), taking into account the spherical aberration of the objective lens and crosstalk between the recording layers. The space layer 25 is generally equal to the thickness of the adhesive layer with which the two substrates are bonded. In an actual manufacture, the distance is determined, taking into account the bonding accuracy and the formation accuracy of the signal substrate 16. The linear recording density is reduced by 10% in a single-sided single layer disc. The capacity per layer is 4.27 GB. Jitter is less than 8%.

<Reflectivity and Others of the Recording Layers>

The Reflectivity of the recording layer is determined as follows:

Single layer disc: 45% to 85% (with PBS), 60% to 85% (without PBS: circularly polarized light)

Dual layer disc: 18% to 30% (with PBS), 18% to 30% (without PBS: circularly polarized light)

Information indicating the Reflectivity of the disc is b29 in a 4-byte ID (Identification Data) in a Data frame:

0b: when the Reflectivity is larger than 40% (with PBS)

1b: when the Reflectivity is equal to or smaller than 40% (with PBS)

Moreover, in the ID, the following have been written:

| | | |
|---|---|---|
| Area type | b27 to b26 | |
| | 00b | In the Data area |
| | 01b | In the Lead-in area |
| | 10b | In the Lead-out area |
| | 11b | In the Middle area |
| Data type | b25 | |
| | 0b | Read-only data |
| | 1b | Other than Read-only data |
| Layer number | b24 | |
| | 0b | Layer 0 of DL discs or on SL discs |
| | 1b | Layer 1 of DL discs |

As for information as to whether the disc has a single layer or a dual layer, a disc structure is defined in byte position (BP2) in the control data zone. In the information, the fifth and sixth bits (b5 and b6) represent the number of recording layers:

00b Single

01b Dual

Others: reserved

Furthermore, the capacity per layer in a single layer disc differs from that in a dual layer disc, since the single layer disc differs from the dual layer disc in linear recording. Recording density is defined in BP3 in such a manner that b7 to b4 represent a linear recording density as follows:

0000b: 0.267 μm (the linear recording density for a single layer)

0001b: 0.293 μm (the linear recording density for a dual layer)

<Next-Generation DVD>

As frequently reported in recent years, a blue-violet semiconductor laser (hereinafter, referred to as blue-violet laser) HD DVD whose recording density is three times or more as high as that of DVD has been proposed to satisfy the desire to store high definition (HD) images on a single disc. The blue-violet laser HD DVD has been standardized in the DVD Forum (refer to www.dvdforum.org. It has not been produced yet on a commercial basis).

HD DVD has the same disc structure as that of a conventional DVD. A single-sided single layer HD DVD has a capacity of 15 GB and a double-sided dual layer HD DVD has a capacity of 30 GB. These large capacities have been realized by new techniques, including a shorter wavelength of laser light, a larger NA, a modulation system, and new signal processing (PRML: Partial Response and Maximum Likelihood).

FIG. 5 shows the relationship between the basic structure of a single-sided single layer HD DVD disc 40a and an optical head. Like the DVD disc 10, the HD DVD 40a has such a structure as has two 0.6 mm thickness disc substrates bonded together. One is a signal substrate 41 and the other is a dummy substrate 44. The two substrates are bonded together with an adhesive layer 45 in such a manner that a recording layer 50 between the two substrates. The center value of the recording layer 50 on a light transmission layer 43 is 600 μm. Because of the spherical aberration of the objective lens 65, the light transmission layer 43 has a maximum value of 613 μm and a minimum value of 587 μm. The recording layer 50 formed at the signal substrate 41 is read with a blue-violet laser beam 60 (of wavelength 405 nm) stopped down with the objective lens 65 (of NA 0.65).

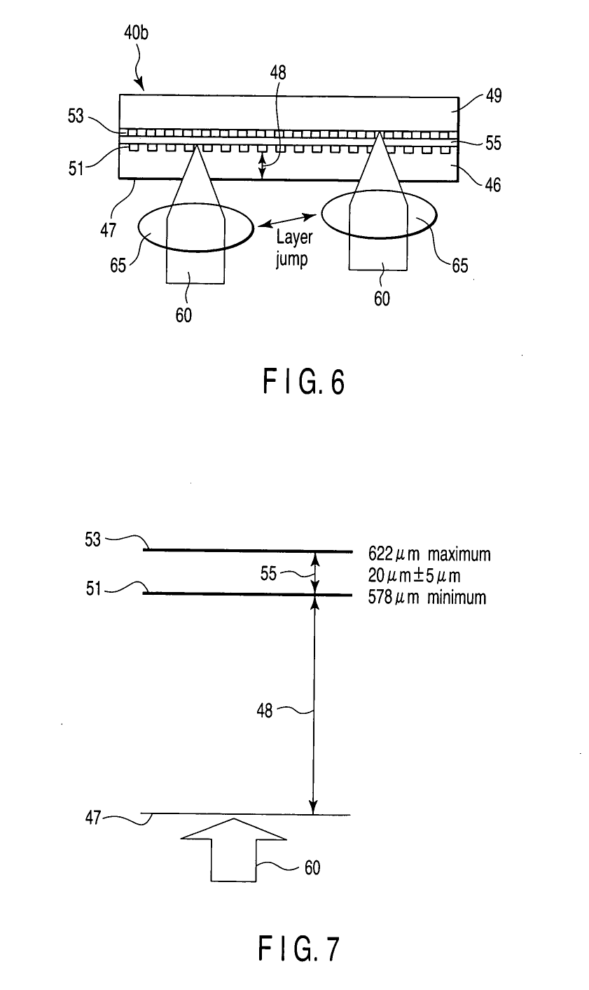

FIG. 6 shows the relationship between the basic structure of a single-sided dual layer HD DVD disc 40b and an optical head. The HD DVD disc 40b has such a structure as has a signal substrate 46 (where a recording layer L0 51 has been formed) and a signal substrate 49 (where a recording layer L1 53 has been formed) bonded together with a space layer 55. As in DVD, causing the focused position of the laser beam to jump between the recording layers enables the recording layer L0 51 or L1 53 to be accessed from one side of the disc.

FIG. 7 shows the positions of the recording layers of the single-sided dual layer HD DVD when viewed from the incidence plane 47. Since the spherical aberration becomes severer as a result of making the wavelength shorter and NA larger, the first recording layer 51 is limited to a position a minimum distance of 578 μm away from the incidence plane and the second recording layer 53 is limited to a position a maximum distance of 622 μm away from the incidence plane. The distance between the two layers (or space layer 55) is set as 20+5 μm (15 to 25 μm).

<Existing DVD and Next-Generation DVD>

If a large-capacity HD DVD capable of accumulating HD images is proposed, an HD DVD apparatus (drive or player) can be newly designed so that it can read not only HD DVD but also DVD. However, since the HD DVD differs greatly from the DVD in recording density, modulation system, signal processing, track format, and others, a conventional DVD apparatus (drive or player) cannot read the data from the HD DVD disc. That is, the conventional DVD apparatus has the problem of being unable to read not only the HD movie content recorded on the HD DVD disc but also the conventional DVD movie content recorded on the HD DVD disc.

To overcome this problem, the inventors of this invention have come up with an optical disc, an optical disc apparatus, and an optical disc reproducing method which enable a single disc to handle not only the information recorded on the next-generation DVD but also the information recorded on the existing DVD, and further with a digital content publication using an optical disc as a recording medium.

<The Basic Concept of this Invention is as Follows>

An optical disc according to the present invention is basically specified by the following items (1) to (4):

(1) The optical disc is a single-sided dual layer optical disc where a light transmission layer, a first recording layer accessed with a first laser beam, a space layer, and a second recording layer accessed with a second laser beam are arranged in that order in the direction in which the laser beam enters.

(2) The distance in the light transmission layer from the incidence plane to the first recording layer is 578 to 598 μm.

(3) The distance in the space layer from the first recording layer to the second recording layer is 32 to 42 μm.

(4) The areal recoding density of the first recording layer is three times or more that of the second recording layer.

An optical disc of the present invention can be embodied on the basis of not only the above basic items but also the following items (5) and (6):

(5) The reflectivity of the first recording layer with respect to the first laser beam is 4% or more.

(6) The reflectivity of the second recording layer with respect to the second laser beam is 45% or more.

The optical disc apparatus of the present invention can be embodied on the basis of not only the above items but also the following item (7):

(7) The reflectivity of the second recording layer with respect to the second laser beam is larger than that of the first recording layer with respect to the first laser beam.

Moreover, the optical disc apparatus of the present invention can be embodied on the basis of not only the above items but also the following item (8):

(8) The transmittance of the first recording layer with respect to the second laser beam is larger than that of the first recording layer with respect to the first laser beam.

Furthermore, the optical disc apparatus of the present invention can be embodied on the basis of not only the above items but also the following items (9) and (10):

(9) The first recording layer is made of an Ag alloy film.

(10) The second recording layer is made of an Au film.

An optical disc apparatus according to the present invention is specified by the following items (11) to (16):

(11) The optical disc apparatus is an apparatus for reading the information recorded on an optical disc.

(12) The optical disc is such that a light transmission layer, a first recording layer accessed with a first laser beam, a space layer, and a second recording layer accessed with a second laser beam are arranged in that order in the direction in which the laser beam enters.

(13) The distance in the light transmission layer from the incidence plane to the first recording layer is 578 to 598 μm.

(14) The distance in the space layer between the first recording layer and the second recording layer is 32 to 42 μm.

(15) The areal recoding density of the first recording layer is three times or more as high as that of the second recording layer.

(16) The apparatus for reading the information comprises an optical head capable of generating a first laser beam and a second laser beam and control means for selectively causing the first laser beam or the second laser beam to be generated.

The optical disc apparatus of the present invention can be embodied on the basis of not only the above basic items but also the following item (17):

(17) Control means selects either the first laser beam or the second laser beam on the basis of the user input from a user interface.

The optical disc apparatus of the present invention can be embodied on the basis of not only the above basic items but also the following item (18):

(18) Control means selects the first laser beam in an initial process of trying reading information on the installed optical disc.

The optical disc apparatus of the present invention can be embodied on the basis of not only the above basic items but also the following item (19):

(19) Control means, when having read information in the initial process, continues selecting the first laser beam until a user input to select the second laser beam has been supplied from the user interface

According to the present invention, there is provided an optical disc which enables a first recording layer (corresponding to an HD DVD layer) and a second recording layer (corresponding to a DVD layer) to be accessed from one side with a first laser beam (or blue-violet laser light) and a second laser beam (red laser light), respectively. Therefore, both DVD movie content and HD DVD movie content can be recorded into a single disc. That is, this disc is a combination disc capable of dealing with both SD video and HD video.

A conventional DVD compatible optical disc apparatus can reproduce DVD content. A new HD DVD compatible optical disc apparatus can reproduce HD DVD movie content or both HD DVD movie content and DVD movie content.

For instance, the same movie content is prepared in the form of DVD content and HD DVD content. These two movie contents are recorded into a single disc. This enables the user having only a DVD compatible apparatus to watch the DVD movie content and the user having an HD DVD compatible apparatus to watch the HD DVD movie.

If the user who does not have an HD DVD compatible apparatus buys an HD DVD compatible apparatus in the future, the user can enjoy the HD video on the already bought discs without buying a new HD DVD disc. This provides a great benefit to the user.

<Basic Configuration of an Optical Disc According to this Invention>

FIG. 8 shows the relationship between an optical disc 70 according to an embodiment of the present invention and an optical head. The optical disc 70 is composed of a first substrate 71 and a second substrate 72. In the optical disc 70, a first recording layer (corresponding to an HD DVD layer) 81 made of a transparent film is formed closer to the incidence plane 73 of a laser beam and a second recording layer (corresponding to a DVD layer) 83 made of a high reflection film is formed less close to the incidence plane.

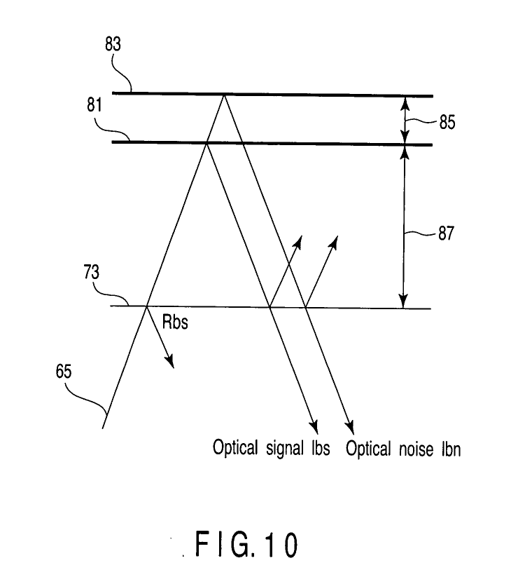

FIG. 9 shows a state where the information recorded in the second recording layer (DVD layer) 83 is reproduced with the red laser beam 30 and FIG. 10 shows a state where the first recording layer (HD DVD layer) 81 with the blue-violet laser beam 60. To reproduce data from the HD DVD layer 81 with a blue-violet laser beam, the HD DVD layer has to be a minimum distance of 578 μm and a maximum distance of 622 μm away from the incidence plane (because of limitations of spherical aberration) as seen from FIG. 8. In addition, if the DVD layer 83 is a normal single layer, the DVD layer has to be a minimum distance of 570 μm and a maximum distance of 630 μm away from the incidence plane. However, as in the thin single layer, if jitters in the recording layers are reduced to 7% or less, the normal single layer can be formed to a thickness of up to 640 μm. The space layer 85 is determined, taking into account a crosstalk occurring between the DVD layer 83 and the HD DVD layer 81. In the case of the HD DVD, the space layer 85 has a thickness of 15 μm or more. In the case of the DVD, the space layer 87 has a thickness of 40 μm or more. Both cases depend on the optical system.

In the first substrate 71, the HD DVD layer 81 is formed. The red laser beam 30 reproducing data from the DVD layer 83 passes through the HD DVD layer 81. If the thickness accuracy of the substrate is +10 μm almost equal to that of HD DVD, the light transmission layer 87 has a minimum thickness of 578 μm and a maximum thickness of 598 μm. Therefore, taking into account that the position of the DVD layer 83 has to be 640 μm or less from the incidence plane, the thickness of the space layer 85 is 42 μm maximum. In the case of HD DVD, since the space layer is 20±5 μm in thickness, if the thickness of the space layer 85 can be controlled to almost the same extent as in HD DVD, the thickness of the space layer 85 can be set to 32 to 42 μm.

As described above, according to the present invention, if the maximum value of the thickness accuracy of the substrate has been determined, the maximum value of the thickness of the space layer is determined. As for the minimum value, it is necessary to take into account interlayer crosstalk between the HD DVD layer and the DVD layer.

<Reflectivity and Others>

For the optical disc to be recognized as a single-sided single layer disc with one of the conventional DVD apparatuses commercially available in large quantities, the optical signal Irs from the DVD layer 83 has to be 45% or more of the red laser beam 30. If the blue-violet laser beam 60 is irradiated onto the same disc, the optical signal Ibs from the HD DVD layer 81 has to be subjected to focus servo and tracking servo and be reproduced.

The reflectivity of blue-violet laser light is determined in the HD DVD standard as follows:

In the case of HD DVD-ROM
Single-sided single layer disc 40% to 70% (including birefringence)
Single-sided dual layer disc 18% to 32% (including birefringence)

HD DVD-Rewritable (at system Lead-in area)
Single-sided single layer disc 4% to 8% (including birefringence)

In the case of an optical disc of the present invention, since the position of the HD DVD layer is made equal to that in a single-sided dual layer disc of an HD DVD-ROM, it is desirable that the reflectivity should fall in the determined range. Since HD DVD has not been produced on a commercial basis, new requirements for the HD DVD layer of the optical disc can be added. In that case, the lower limit of the reflectivity has to be larger than that of an HD DVD-Rewritable disc.

In the case of a single-sided dual layer disc shown in FIG. 4, since the reproducing light is the red laser beam 30, Au or Si is generally used as a semi-transparent film in the first recording layer 21. In the second recording layer 23 of a high-reflectivity film, low-cost Al alloy is used.

In the case of HD DVD shown in FIG. 6, however, use of Au or Si makes it difficult to form a translucent film in a suitable range for the blue-violet laser beam. Therefore, the translucent first recording layer (L0 layer) 51 is made of Ag alloy and the second recording film (L1 layer) 53 of a high-reflectivity film is made of Ag alloy or Al alloy.

Hereinafter, a case where the first recording layer (HD DVD layer) (translucent layer) 51 of the optical disc 70 is made of Ag alloy and the second recording layer (DVD layer) (high reflectivity) 53 is also made of Ag alloy will be explained.

FIG. 9 shows a case where the red laser beam 30 is caused to enter the optical disc 70. The reflectivity (Rrs) at the incidence plane 73, which is determined by the refractive index of the first substrate 71 with respect to the red laser beam 30, is 4.8% (with no antireflection). The light transmission layer 87 is also used as a light transmission layer for the HD DVD layer 81. Therefore, if birefringence is set as 40 nm or less through double pass (the birefringence of HD DVD-rewritable disc is 40 nm or less), a decrease in the amplitude caused by birefringence is 3.7% maximum.

The reflectivity Rr2 of the DVD layer made of Ag alloy is about 92% with respect to the red laser beam. The absorptance of the translucent film made of Ag alloy with respect to the red laser beam is as small as about 3%. Thus, it follows that the reflectivity (Rr1)+the transmittance≈97%.

Therefore, the optical signal Irs from the DVD layer 83 has a value of 0.952²×(the transmittance of the HD DVD layer)²×0.92×0.963×100%. For this value to be 45% or larger, the transmittance of the HD DVD layer has to be 75% or more. At this time, the reflectivity Rr1 of the HD DVD layer is about 21% and optical noise Irn is 18.3% (=0.952²×0.21×0.963×100%).

Next, FIG. 10 shows a case where the blue-violet laser beam 60 is caused to enter the optical disc. The reflectivity (Rbs) at the incidence plane with respect to the blue-violet laser beam 60 is 5.3%. A decrease in the amplitude caused by the birefringence of the light transmission layer 87 is 9.3% maximum (40 nm through double pass). The reflectivity of the HD DVD layer 81 made of Ag alloy with respect to the blue-violet laser beam is about 6.4%, because the film of Ag alloy is thin. Therefore, the optical signal Ibs has a value of 5.2% (=0.947²×0.907×6.4%).

If the transmittance of the HD DVD layer with respect to the blue-violet laser beam is 88% and the reflectivity of the DVD layer made of Ag alloy with respect to the blue-violet laser beam is 71%, optical noise Ibn from the DVD layer 83 has a value of 44.7% (=0.947²×0.88²×0.907×0.71×100%), which is an extremely large value.

Therefore, interlayer crosstalk becomes a big problem.

To overcome this problem, consideration will be given to a case where Au, which presents a high reflectivity to the red laser beam and a low reflectivity to the blue-violet laser beam, is used as the reflecting film of the DVD layer.

The reflectivity of Au with respect to the red laser beam is about 83% lower than that of Ag alloy. As with Al alloy, the optical signal Irs from the DVD layer 83 has a value of 0.952²×(the transmittance of the HD DVD layer)²×0.83×0.963×100%. For this value to be 45% or larger, the transmittance of the HD DVD layer has to be 78.8% or more. At this time, the reflectivity Rr1 of the HD DVD layer is about 17% and optical noise Irn is 14.8% (=0.952²×0.17×0.963×100%).

Next, a case where the blue-violet laser beam 60 is caused to enter the optical disc is calculated. A reflection loss at the incidence plane and a decrease due to birefringence are 5.3% and 9.3%, respectively. The reflectivity of the HD DVD layer 81 made of Ag alloy with respect to the blue-violet laser beam is about 5.3% and the transmittance is 90%. Therefore, the optical signal Ibs has a value of 4.3% (=0.9472×0.907×5.3%), clearing the target of 4%.

Next, optical noise Ibn is calculated. The transmittance of the HD DVD layer (Ag alloy film) with respect to the blue-violet laser beam is as high as 90% and the reflectivity of the DVD layer (Au film) with respect to the blue-violet laser beam is low, about 30%. Thus, optical noise from the DVD layer 83 has a value of 19.8% (=0.9472×0.92×0.907×0.3×100%), which is less than half the value obtained when Ag alloy film is used as the DVD layer.

<Interlayer Crosstalk and Space Layer>

Next, interlayer crosstalk and the thickness of the space layer are considered. In FIG. 9, when data is reproduced from the DVD layer 83 with red laser light, the light reflected from the HD DVD layer 81 becomes optical noise Irn. Since the reproducing optical system of the optical head has the function of forming an image of the HD DVD layer 83 on the surface of the photo-detector, the optical noise Irn reflected at the DVD layer 81 contributes to the photo-detector by the square of the thickness of the space layer 85.

In the single-sided dual layer DVD disc using a red laser beam shown in FIG. 4, the minimum value of the space layer is set as 40 μm. At this value, interlayer crosstalk is at a negligible level. The reflectivity of the first recording layer 21 is determined so that the reflected lights from the two layers may be almost the same.

As shown in FIG. 9, when data is reproduced from the DVD layer 83 with red laser light 30, optical noise Irn from the HD DVD layer 81 is 14.8% of the incident light. It is ⅓ (= 14.8/45) (birefringence: 40 nm) of 45% of the optical signal Irs from the DVD layer 83. This means that, even if the value decreases to 23 μm (=40 μm/\sqrt{3}) with the space layer 85 having a minimum value of 40 μm, the amount of interlayer crosstalk is the same.

Next, as shown in FIG. 10, when data is reproduced from the HD DVD layer 81 with blue-violet laser light 60, optical signal Ibs is 4.3% of the incident light. Since optical noise Ibn is 19.8% of the incident light, it is 4.6 times as much as the optical signal Ibs. Since the minimum value of the space layer is 15 μm in the HD DVD standard, the minimum value of the space layer is set to 32 μm (=15 μm×\sqrt{4.6}) to reduce the optical noise to the same level.

From the above consideration, it is found that the minimum value of the space layer has to be 32 μm.

<Flag Information>

Next, a set of flags in an optical disc of the present invention will be explained. The DVD layer 85 has to be treated as an ordinary single-sided single layer DVD disc. ID of Data frame and BP2 in Physical format information in the control data zone are set as a single-sided single layer disc.

In the HD DVD layer 81, ID of Data frame and BP2 in Physical format information in the control data zone are set as a single-sided single layer disc.

A flag which indicates that an optical disc according to this invention has two layers, a DVD layer and an HD DVD layer, is written in, for example, the following positions. It is desirable to use reserved bits in a disc structure where (BP2) is in Physical format information in the control data zone. There are two reserved bits: one is b7 and the other is a used bit b3 in Layer type. This bit is reserved not only in ROM but also Rewritable and R, which therefore means that the bit has no effect.

In Disc structure of (BP2), b3 is defined as follows:

b3 0b reserved

1b HD DVD layer is allocated to the first layer and DVD layer is allocated to the second layer

<Reproduction by an Optical Disc Apparatus Complying with the DVD Standard>

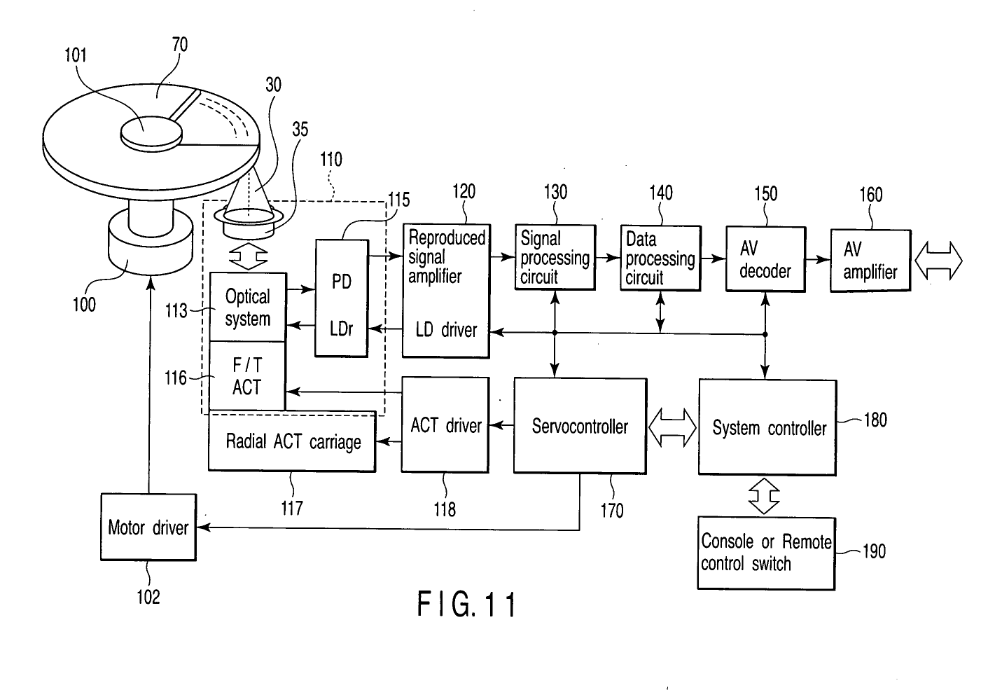

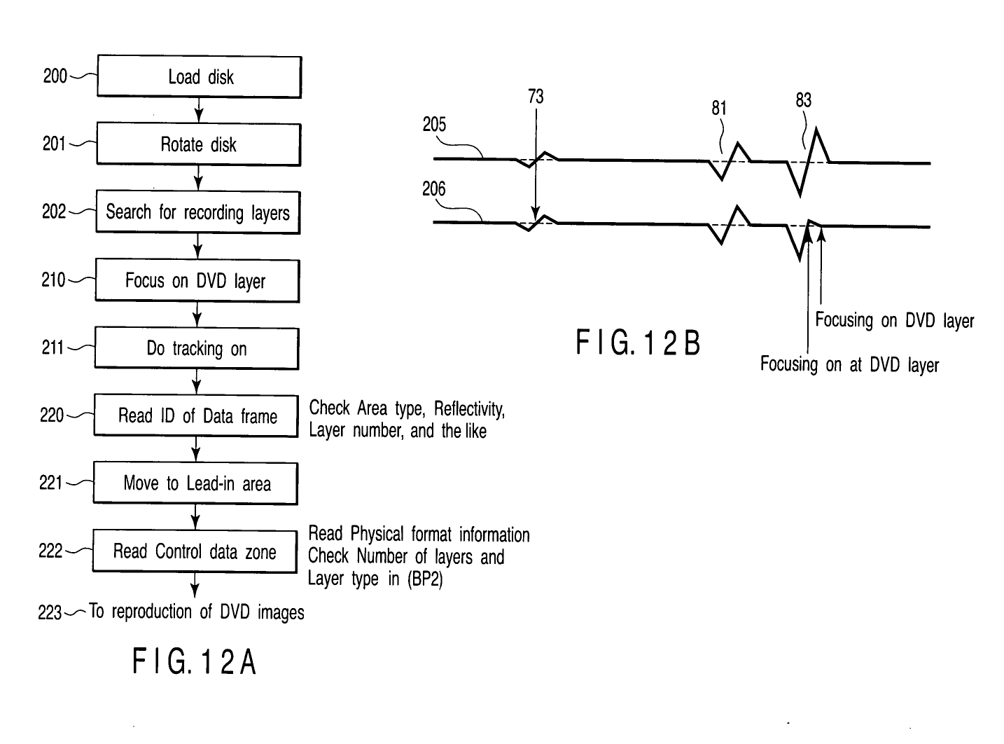

Next, a case where a disc of this invention is played back on a conventional DVD apparatus will be explained using FIGS. 11 and 12. FIG. 11 shows a main configuration of a well-known DVD apparatus. FIG. 12 is a flowchart to help explain the operation of the DVD apparatus and shows focus servo.

A main configuration of the DVD apparatus will be explained briefly. A spindle motor 100 rotates a turntable. A damper 101 holds an optical disc 70 in place on the turntable. The spindle motor 100 is controlled by a motor driver 102. An optical head 110 includes an objective lens 35 and an optical system 113. The optical system 113 is driven by a focus and tracking actuator 116. When the focus and tracking actuator 116 is controlled by an actuator driver 118, the laser beam is focused on a track on the optical disc and follows the track. A radial actuator 117 is used to move the optical head 110 in the direction of radius of the optical head 110 and is controlled by the actuator driver 118.

The reflected light from the disc is taken out of the optical system 113 and is converted into an electric signal at a photo-detector in a conversion unit 115. The electric signal is gain-adjusted at a reproduced signal amplifier in a gain adjusting unit 120 and the resulting signal is input to a signal processing circuit 130. The signal processing circuit 130 performs a demodulating process, buffering, error correction, and others and inputs the resulting signal to a data processing circuit 140. The data processing circuit 140 performs packet separation, control signal separation, and the like and inputs video and audio information to an AV decoder 150. The video signal, audio signal, sub-video signal, and the like demodulated at the AV decoder 150 are output as a base-band signal via an AV amplifier 160.

Using a focus error signal and tracking error signal obtained by, for example, processing numerically the reproduced signal from a 4-quadrant photodiode, a servo controller 170 supplies a control signal to the actuator driver 118. In response to a signal from console (e.g., a remote controller or an operation key input section) 190, a system controller 180 controls the playback, stop, temporary stop, and the like. In addition, the system controller 180 controls the laser diode driver in the gain adjusting unit 120. The laser diode driver drives the laser diode installed in the optical head 110, thereby outputting a red laser beam 30.

When an optical disc 70 of the present invention is installed in the DVD apparatus, the spindle motor 100 is rotated until a specific number of revolutions has been reached. Next, a periodic driving current is caused to flow through the focus actuator 116, thereby moving the optical head up and down in the direction of axis (in steps 200 to 202 in FIG. 12A). A focus signal 205 (FIG. 12B) produced from the reproduced signal appears periodically. Since the level of the focus signal from the DVD layer is twice the level of the signal from the HD DVD layer, the DVD apparatus generally recognizes the disc as a single-sided single layer DVD disc and focuses on the DVD layer (step 210) as shown by numeral 206 in FIG. 12B.

Then, after a short stabilization time elapses, on-focus is turned on. Then, the tracking servo is turned on, thereby tracking on a suitable position of the disc (step 211). In this state, ID of Data frame is read (step 220), Area type, Reflectivity, Layer number, and others of the disc are checked. Then, the radial actuator 117 is driven, moving the optical head 110 to the Lead-in area (step 221). Next, the optical head is moved to the Control data zone (step 222) and reads Number of layers and Layer type from (BP2) in Physical formation information, thereby verifying that the disc is a single-sided single layer DVD disc, which is followed by the reproduction of DVD images (step 223).

Depending on the apparatus, the disc might be determined to be a single-sided dual layer DVD disc and therefore the HD DVD layer might be read, although the level of the signal from the HD DVD layer is small. However, since a specific signal cannot be obtained from the HD DVD, the DVD layer is focused on again and is read.

<Reproduction by an Optical Disc Apparatus Complying with the HD DVD Standard>

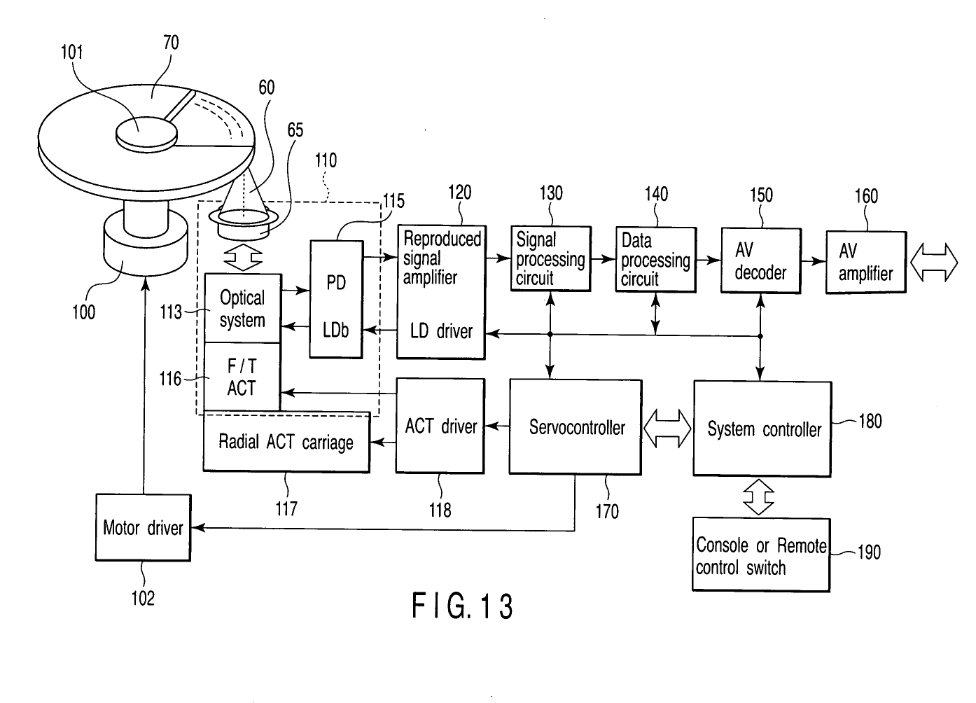

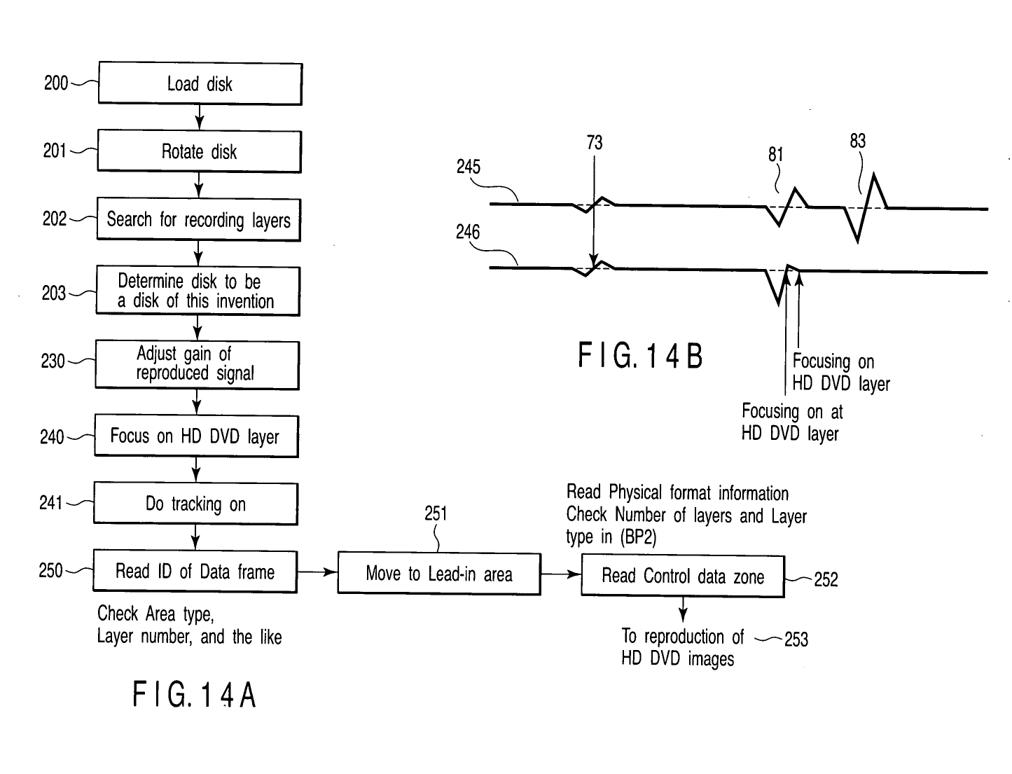

Next, an HD DVD apparatus using blue-violet laser light will be explained using FIGS. 13, 14A, and 14B. As shown in FIG. 13, since the HD DVD apparatus has almost the same functional blocks as in the configuration of the DVD apparatus shown in FIG. 11, the like parts are indicated by the same reference numerals in FIG. 11. In the case of the HD DVD apparatus, a laser diode that outputs blue-violet laser light is provided in a photoelectric conversion unit 115. The objective lens 65 differs from the objective lens 35 in numerical aperture.

First, a periodic driving current is caused to flow through the focus actuator 116, thereby obtaining focus signals 245 in FIG. 14B. From changes in the levels of the focus signals 245, it is recognized that there are two recording layers. Moreover, from the fact that the level of one signal is more than twice the level of the other signal, the disc is a disc of the present invention (steps 200 to 203). In this case, the gain of the reproduced signal is adjusted (step 230) and the HD DVD layer is focused on (step 240). After a short stabilization time elapses, the HD DVD layer goes into the on-focused state (refer to the focus signal 246 in FIG. 14B) (step 240). Then, the tracking servo is turned on (step 241), which causes the disc to be tracked on in a suitable position.

Then, ID of Data frame is read (step 250), Area type, Layer number, and others of the disc are checked. Then, the radial actuator 117 is driven, moving the optical head 110 to the Lead-in area (step 251). Next, the optical head is moved to the Control data zone (step 252) and reads Number of layers and Layer type from (BP2) b3 in Physical format information, thereby verifying that the disc is a single-sided single layer HD DVD disc, which is followed by the reproduction of HD DVD images (step 253).

<Reproduction by an Optical Disc Apparatus Complying with Both of the DVD Standard and HD DVD Standard>

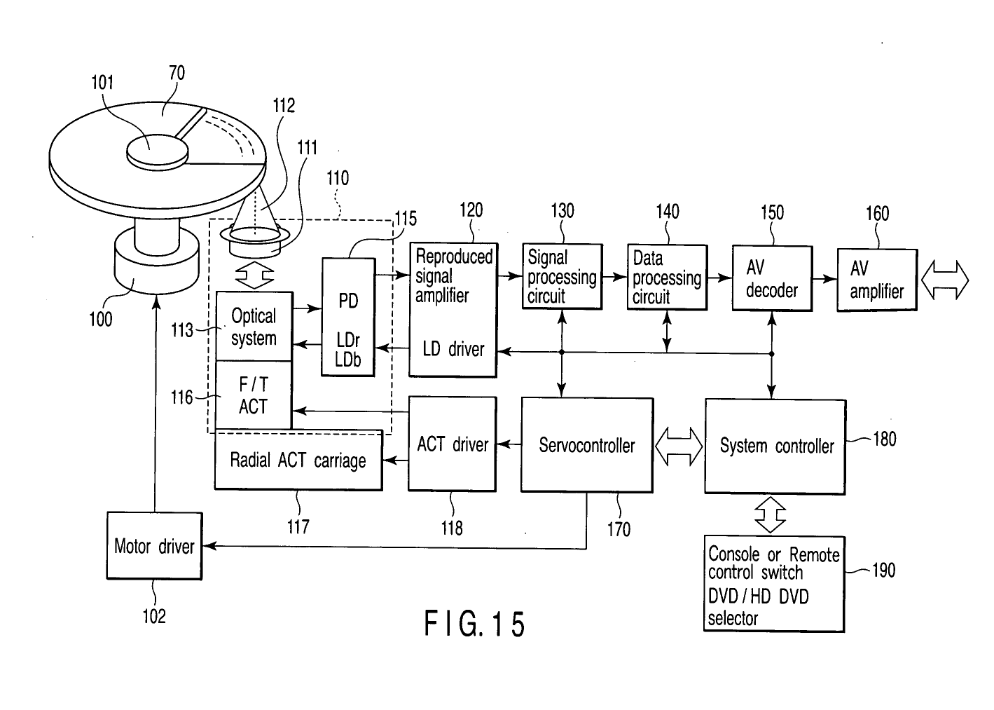

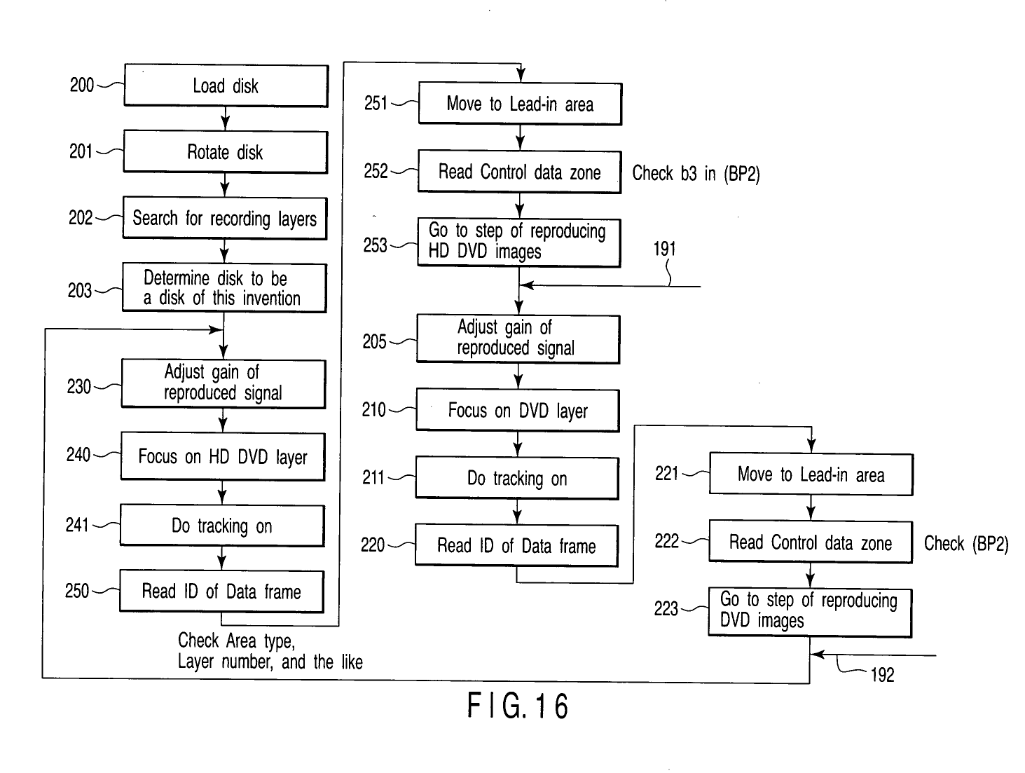

Next, a compatible apparatus of the present invention using both of red laser light and blue-violet laser light will be explained using FIGS. 15 and 16.

As shown in FIG. 15, since the compatible apparatus has almost the same functional blocks as in the configuration of the DVD apparatus shown in FIG. 11 and in the configuration of the HD DVD shown in FIG. 13, the like parts are indicated by the same reference numerals in FIGS. 11 and 13. In the case of the compatible apparatus, a laser diode LDr that outputs red laser light and a laser diode LDb that outputs blue-violet laser light are provided in a photoelectric conversion unit 115. The objective lens 111 is selective according to, for example, the wavelength of a laser beam. The numerical aperture changes adaptively between a red laser beam and a blue-violet laser beam. Alternatively, the objective lens may be of the switching type.

In the compatible apparatus, first, a blue-violet laser beam is turned on, thereby driving the focus actuator 116. Then, a change in the level of the focus signal is detected and managed, thereby determining that the disc is a disc of the present invention (steps 200 to 203). The amplitude of the focus error signal from the first recording layer is, for example, more than twice that of the focus error signal from the second recording layer or vice versa. The level of the focus error signal from DVD is larger and the level of the focus error signal from HD DVD is smaller.

Next, the gain of the reproduced signal is adjusted (step 230), the HD DVD layer is focused on (step 240). Thereafter, tracking-on is done (step 241). Then, ID of Data frame is read (step 250), the optical head is moved to the Lead-in area (step 251) and reads Physical format information in the Control data zone (step 252).

Then, from the flag in b3 in Layer type of Disc structure in (BP2), it is verified whether the disc is a disc of the present invention. Next, Number of layers and Layer type are checked, thereby verifying that the layer currently being accessed is an HD DVD layer, which is then followed by the reproduction of HD DVD images.

Here, if the user selects DVD by using the console or Remote control switch 190 (or by operating the switch 191 on the Remote control switch), the gain of the reproduced signal is adjusted (step 205), the DVD layer is focused on (step 210), tracking-on is done (step 211), and ID of Data frame is checked. Then, the optical head is moved to the Lead-in area (step 221) and the flag of the Control data zone is checked (step 222), following by the reproduction of DVD images.

Here, if the user selects HD DVD (by operating the switch 192 on the Remote control switch), HD DVD images can be reproduced in the aforementioned method (step 253).

In step 230 and step 205 explained above, the gain of the reproduced signal is adjusted. The reason is that, as described above, there is a big difference between the intensity of the reflected light from the disc on which red laser light is irradiated and the intensity of the reflected light from the disc on which blue-violet laser light is irradiated. Therefore, the gain adjustment is made so that the level of the signal input to the signal processing circuit 130 may be constantly at a stable level. Such an operation is a distinctive characteristic of this apparatus.

As described above, with the present invention, DVD and HD DVD can be formed in a single optical disc. In this invention, an existing DVD apparatus can reproduce data from the DVD layer, an HD DVD complying with the HD DVD standard can reproduce data from the HD DVD layer, and a compatible apparatus of this invention can reproduce data from both of the DVD layer and the HD DVD layer. In addition, with the present invention, a group of products complying with the existing DVD standard is compatible with a group of products complying with the new HDD DVD standard, which helps a group of products complying with the HD DVD standard to spread smoothly among ordinary users.

### OTHER EMBODIMENTS

In the above embodiment, the translucent film of the first recording layer has been made of Ag alloy. If reflectivity and transmittance can be set for each of the two laser beams differing in wavelength, the apparatus can be operated more efficiently.

For example, if the first recording layer is made of a multiple interference film or the like, the reflectivity to the first laser beam (or blue-violet laser beam) can be made higher than that to the second laser beam (or red laser beam). Moreover, the transmittance of the first recording layer with respect to the second laser light can be set higher than that with respect to the first laser light.

This invention is not limited to the above embodiments and may be embodied by modifying the component elements without departing from the spirit or essential character thereof. In addition, various inventions may be formed by combining suitably a plurality of component elements disclosed in the embodiments. For example, some components may be removed from all of the component elements constituting the embodiments. Furthermore, component elements used in two or more embodiments may be combined suitably.

According to the present invention, it is possible to provide an optical disc which enables a first recording layer (corresponding to an HD DVD layer) and a second recording layer (corresponding to a DVD layer) to be accessed from one side with a first laser beam (or blue-violet laser) and a second laser beam (red laser), respectively. Therefore, for example, both DVD movie content and HD DVD movie content can be recorded into a single disc. That is, this disc is a combination disc capable of dealing with both standard definition (SD) video and high definition (HD) video.

Then, a conventional DVD compatible optical disc apparatus can reproduce DVD content and a new HD DVD compatible optical disc apparatus can reproduce HD DVD movie content or both HD DVD movie content and DVD movie content.

For example, the same movie content is prepared in the form of DVD content and HD DVD content. These two movie contents are recorded into a single disc. This enables the user having only a DVD compatible apparatus to watch the DVD movie content and the user having an HD DVD compatible apparatus to watch the HD DVD movie.

If the user who does not have an HD DVD compatible apparatus buys an HD DVD compatible apparatus in the future, the user can enjoy the HD video on the already bought discs without buying a new HD DVD disc. This provides a great benefit to the user.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical disc with a single-sided dual layer where a light transmission layer, a first recording layer accessed with a first laser beam, a space layer, and a second recording layer accessed with a second laser beam are arranged in that order in the direction in which a laser beam enters, the optical disc comprising:
the distance in the light transmission layer from an incidence plane to the first recording layer being 578 to 598 μm;
the distance in the space layer between the first recording layer and the second recording layer being 32 to 42 μm; and
the areal recoding density of the first recording layer being three times or more as high as that of the second recording layer.

2. The optical disc according to claim 1, wherein the reflectivity of the first recording layer with respect to the first laser beam is 4% or more, and
the reflectivity of the second recording layer with respect to the second laser beam is 45% or more.

3. The optical disc according to claim 1, wherein the reflectivity of the first recording layer with respect to the first laser beam is smaller than the reflectivity of the second recording layer with respect to the second laser beam.

4. The optical disc according to claim 1, wherein the transmittance of the first recording layer with respect to the second laser beam is larger than the transmittance of the first recording layer with respect to the first laser beam.

5. The optical disc according to claim 1, wherein the first recording film is made of an Ag alloy film and the second recording film is made of an Au film.

6. An optical disc apparatus which reads information recorded on an optical disc where a light transmission layer, a first recording layer accessed with a first laser beam, a space layer, and a second recording layer accessed with a second laser beam are arranged in that order in the direction in which a laser beam enters, the distance in the light transmission layer from an incidence plane to the first recording layer being 578 μm to 598 μm, the distance in the space layer between the first recording layer and the second recording layer being 32 to 42 μm, and the areal recoding density of the first recording layer being three times or more as high as that of the second recording layer, the optical disc apparatus comprising:
an optical head capable of generating the first laser beam and the second laser beam; and
control section for selectively causing either the first laser beam or the second laser beam to be generated.

7. The optical disc apparatus according to claim 6, wherein the control means selects either the first laser beam or the second laser beam on the basis of a user input from a user interface.

8. The optical disc apparatus according to claim 6, wherein the control means selects the first laser beam in an initial process of trying reading information from the installed optical disc.

9. The optical disc apparatus according to claim 8, wherein the control means, when having succeeded in reading information in the initial process, continues selecting the first laser beam until a user input to select the second laser beam has been supplied from the user interface.

10. An optical disc reproducing method of reading information recorded on an optical disc where a light transmission layer, a first recording layer accessed with a first laser beam, a space layer, and a second recording layer accessed with a second laser beam are arranged in that order in the direction in which a laser beam enters, the distance in the light transmission layer from an incidence plane to the first recording layer being 578 to 598 μm, the distance in the space layer between the first recording layer and the second recording layer being 32 to 42 μm, and the areal recoding density of the first recording layer being three times or more as high as that of the second recording layer, the optical disc reproducing method comprising:
accessing data with the first laser beam and moving the focus point back and forth in the direction of thickness of the optical disc; and
focusing on the first recording layer, making a gain adjustment, turning on a focus servo, and then turning on a tracking servo.

11. The optical disc reproducing method according to claim 10, further comprising:
reading and checking ID of a data frame from a reproduced signal after turning on the tracking servo and then moving to a control data zone in a Lead-in area;
checking information on the number of layers of physical format information in the control data zone; and
reproducing the signal in the first recording layer.

12. The optical disc reproducing method according to claim 10, further comprising:
selecting blue-violet laser light as the first laser beam irradiated on the optical disc;
moving to a signal reproduced state of the first recording layer;
making an adjustment so as to decrease the gain of the reproduced signal, when receiving a switching signal to switch to the second recording layer;
focusing on the second recording layer and turning on a second tracking servo; and
moving to a signal reproduced state of the second recording layer.

13. The optical disc reproducing method according to claim 12, further comprising:
reading and checking ID of a data frame from the reproduced signal of the first recording layer after turning on the first tracking servo and then moving to a control data zone in a Lead-in area;
checking information on the number of layers of physical format information in the control data zone and reproducing the signal in the first recording layer
reading and checking ID of a data frame from the reproduced signal of the second recording layer after turning on the second tracking servo and then moving to the control data zone in the Lead-in area;
checking information on the number of layers of physical format information in the control data zone and reproducing the signal in the second recording layer.
